(19) United States
(12) Patent Application Publication
(10) Pub. No.: US 2007/0079232 A1
(43) Pub. Date: Apr. 5, 2007

(54) Display system incorporating an electro-mechanical wave transducer

(75) Inventor: Adrianus Johannes Stephanes Maria De Vaan, S-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/582,382

(22) PCT Filed: Dec. 8, 2004
(86) PCT No.: PCT/IB04/52713

§ 371 Date: Jun. 9, 2006

Related U.S. Application Data
(60) Provisional application No. 60/528,633, filed on Dec. 11, 2003.

(51) Int. Cl. G06F 17/00

(52) U.S. Cl. 715/512

(57) ABSTRACT

A display system (20) employs a light source (21), a display panel (31), and an optical filter (23). An optical path (OP) extends from the light source (21) through the optical filter (23) to the display panel (31) where light emitted from the light source (21) propagates along the optical path (OP) through the optical filter (23) to the display panel (31). The display system (20) further employs an Nth order electro-mechanical wave transducer (24, 40) to vibrate the optical filter (23) to thereby facilitate a desired illumination of the emitted light onto the display panel (31).

The present invention generally relates to electromechanical wave transducers and their application in display systems. The present invention specifically relates to electro-mechanical wave transducers and their application for color filtering within display systems.

Projection technology has developed greatly in recent years. A major component of projection technology is light engine technology. Light engine technology includes liquid crystal display (“LCD”), digital light processing (“DLP”), and liquid crystal on Silicon (“LCoS”). Most conventional high-end video systems employ one of these light engine technologies.

LCD projectors simultaneously deliver a constant red, green, and blue image.

DLP projectors use a spinning color wheel. Typically, at any given instant in time, the image on the screen is either red, or green, or blue, and the DLP technology relies upon the unaided eye not being able to detect the rapid changes from one color to another.

LCoS is a reflective display technology where a liquid crystal layer is sandwiched between a transparent top substrate and a silicon backplane. The transparent top substrate normally exists of a glass plate covered with a transparent Indium Tin Oxide electrode layer at the inside of the display cell. The silicon backplane contains all the required display drive electronics that drives individual aluminum pixel electrodes. Each pixel as such has an aluminum back electrode that simultaneously acts as an electrode to generate a voltage difference over the liquid crystal layer and as a reflector to reflect the light that is incident on the LCoS display panel.

LCoS projection display systems exist using three (3) display panels, however fast LCoS display panels can be obtained which can be used in a time sequential mode to generate colors, like the DLP systems.

Two principal methods for time sequential color generation can be distinguished.

The conventional method is containing a color wheel that flashes the entire display time sequentially with Red, Green and Blue light. Due to the time sequential color generation, it is possible to use only one (1) display panel to generate a full color image, however at any moment in time the display is illuminated with only one (1) primary color while the other colors are lost. As such, the brightness of these systems is always limited.

Scrolling color technology is another method to generate the time sequential color generation. With this method, the display panel is illuminated with three (3) color bars (e.g., Red, Green and Blue). Using an optical subsystem, these color bars are scrolled time sequentially over the display. As a result, each pixel element in the display receives time sequential Red, Green and Blue light. However, the different parts on the display receive these colors with another phase. With the scrolling color technology, there is no principal light loss for the color generation and higher brightness levels can be achieved compared with the conventional method.

All existing color sequential projection technologies do require however a complex optical subsystem. A rotating color wheel is needed, which requires space and limits product size. In case of a scrolling color system, a very complex color wheel is required containing spiral shaped color filter elements or another system containing many optical parts and rotating prisms.

It would be desirable, therefore, to provide a method and system that would overcome these and other disadvantages.

One form of the present invention is a display system employing a light source, a display panel, and an optical filter. An emission of light by the light source propagates along an optical path extending from the light source through the optical filter to the display panel. The optical filter is vibrated during the emission of the light-by-light source.

A second form of the present invention is a method of operating a display system involving an emission of light from a light source, a propagation of the emitted light through an optical filter to a display panel, and a vibration of the optical filter as the emitted light propagates through the optical filter.

A third form of the present invention is a display system employing an optical filter and a Nth order electromechanical wave transducer that vibrates the optical filter as light is propagated along an optical path traversing through the optical filter.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

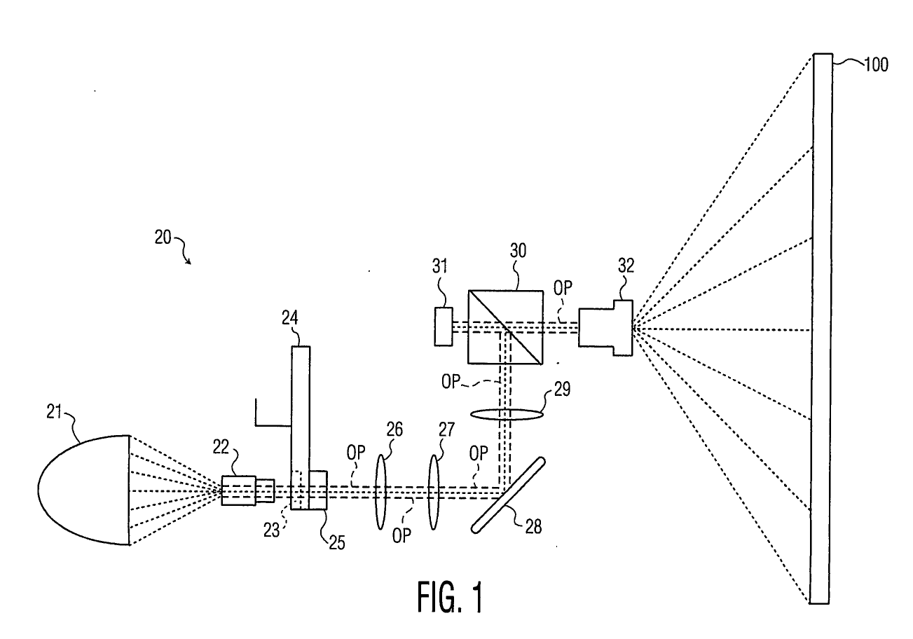

FIG. 1 illustrates one embodiment of a display system in accordance with the present invention;

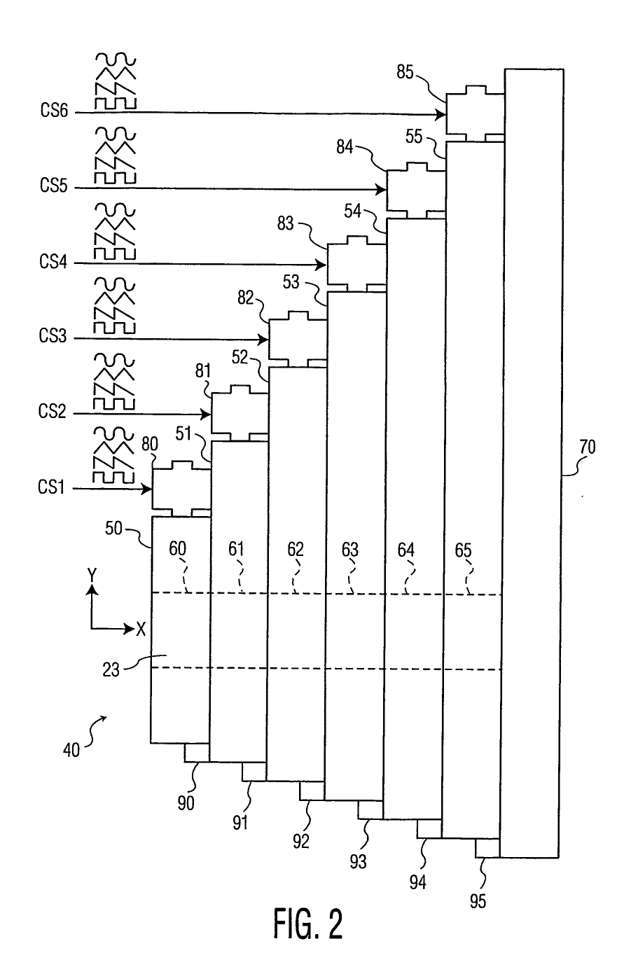

FIG. 2 illustrates a side view of one embodiment of an electromechanical wave transducer in accordance with the present invention;

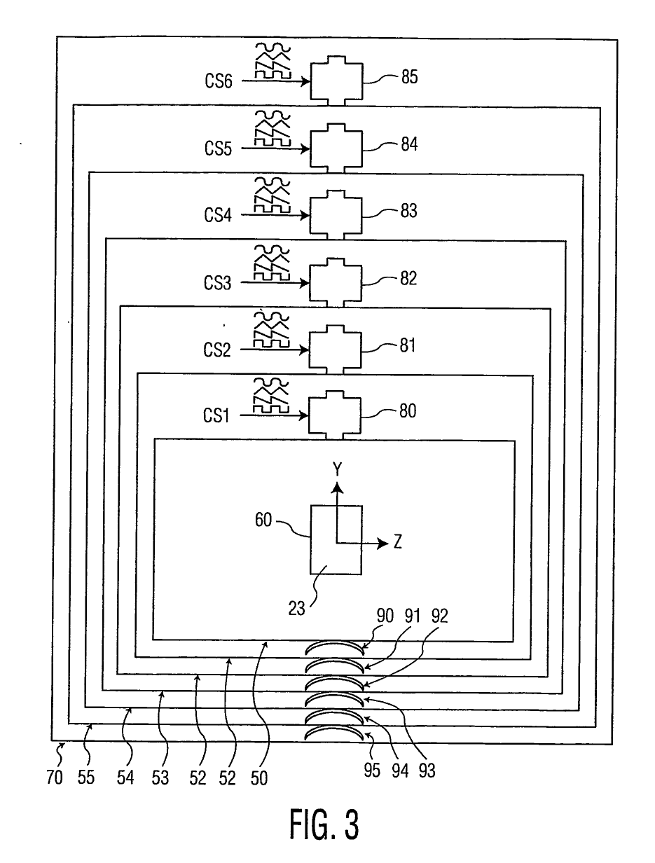

FIG. 3 illustrates a front view of the electromechanical wave transducer illustrated in FIG. 2;

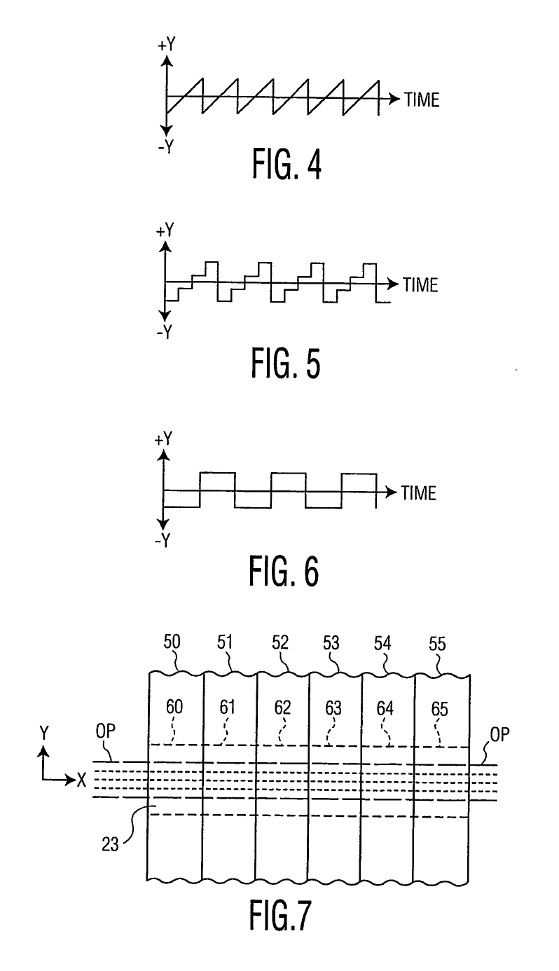

FIGS. 4-6 illustrate various exemplary vibrating waveforms of a dichroic filter embedded within the electromechanical wave transducer illustrated in FIG. 2; and

FIGS. 7-13 illustrate various exemplary shifting movements of stacked plates illustrated in FIG. 2.

A display system 20 illustrated in FIG. 1 projects colored light in a scrolling manner onto a projection screen 100. To this end, system 20 conventionally employs a light source 21, an integrator rod 22, an optical filter 23, a reflective polarizer 25, a lens 26, a lens 27, a mirror 28, a lens 29, a polarizing beam splitter 30, a display panel 31 and a projection lens 32 for establishing an optical path OP. Light source 20 emits light represented by dashed lines that propagates through optical path OP to projection lens 32, which generates a full color image of the display panel 31 projected on projection screen 100. System 20 further employs a new and unique Nth order electromechanical wave transducer 24 for shifting the optical filter 23 relative to optical path OP in a vibrating manner to facilitate a scrolling color illumination of the light on the display panel 31.

Optical filter 23 can be of any conventional type of optical filter. Preferably, optical filter 23 is a dichroic filter, and will therefore be subsequently described herein as dichroic filter 23.

FIGS. 2 and 3 illustrate a 6th order electromechanical wave transducer 40 as one embodiment of Nth order electromechanical wave transducer 24 (FIG. 1). Transducer 40 employs six (6) plates 50-55 stacked on a substrate 70, six (6) transducer units 80-85, and six (6) springs 90-95.

Transducer unit 80 is coupled to plates 50 and 51 to shift plate 50 in an oscillating manner in the ±Y direction along plate 51, and spring 90 is coupled to plate 51 to bias plate 50 in the +Y direction.

Transducer unit 81 is coupled to plates 51 and 52 to shift plate 51 in an oscillating manner in the ±Y direction along plate 52, and spring 91 is coupled to plate 52 to bias plate 51 in the +Y direction.

Transducer unit 82 is coupled to plates 52 and 53 to shift plate 52 in an oscillating manner in the ±Y direction along plate 53, and spring 92 is coupled to plate 53 to bias plate 52 in the +Y direction.

Transducer unit 83 is coupled to plates 53 and 54 to shift plate 53 in an oscillating manner n the ±Y direction along plate 54, and spring 93 is coupled to plate 54 to bias plate 53 in the +Y direction.

Transducer unit 84 is coupled to plates 54 and 55 to shift plate 54 in an oscillating manner in the ±Y direction along plate 55, and spring 94 is coupled to plate 55 to bias plate 54 in the +Y direction.

Transducer unit 85 is coupled to plate 55 and substrate 70 to shift plate 54 in an oscillating manner in the ±Y direction along substrate 70, and spring 95 is coupled to substrate 70 to bias plate 55 in the +Y direction.

Stacked plates 50-55 have apertures 60-65, respectively, and dichroic filter 23 is embedded within aperture 60. As best shown in FIG. 7, apertures 60-65 are sequentially arranged for extending the optical path OP through the individual plates 50-55 in a ±X direction whereby light propagating along optical OP can pass through dichroic filter 23 as dichroic filter 23 is vibrated from an oscillating shifting of one or more of stacked plates 50-55 relative to the optical path OP via transducer units 80-85. To this end, transducer units 80-85 are controlled by wave control signals CS1-CS6 as shown in FIGS. 2 and 3.

Wave control signals CS1-CS6 can have any signal waveform (e.g., sine, triangle, saw tooth, and square waveforms as shown in FIGS. 2 and 3). Those having ordinary skill in the art will recognize that the actual signal waveform of wave control signals CS1-CS6 in practice is selected to vibrate dichroic filter 23 in a manner that facilitates a desired operation of a display system incorporating 6th order electromechanical wave transducer 40. One example is a saw tooth vibrating waveform of dichroic filter 32 relative to optical path OP as illustrated in FIG. 4 to facilitate a scrolling color projection of light on a display panel (e.g., display panel 31 illustrated in FIG. 1). A second example is a step vibrating waveform of dichroic filter 32 relative to optical path OP as illustrated in FIG. 5 to facilitate a flash operation where a display panel is flashed time sequentially with Red, Green and Blue light flashes over the entire display panel. A third example is a block vibrating waveform of dichroic filter 32 relative to optical path OP as illustrated in FIG. 6 to repeat a change in the light on a display panel.

In one embodiment for scrolling color projection, the signal waveform of each wave control signal CS1-CS6 is a sine waveform for vibrating shifting stacked plates 50-55, respectively, relative to optical path OP in saw tooth waveform to thereby vibrate dichroic filter 23, where the sine waveform is in accordance with the following Fourier series equation [1] that approximates a saw tooth vibrating waveform for the dichroic filter 23:

$$f ( χ ) = \frac{1}{2} - \frac{1}{π} {\sum }_{η = 1}^{∞} \frac{1}{η} sin ( \frac{ηπχ}{L} ) \qquad [ 1 ]$$

where L is the period of the waveform.

There are numerous vibrating modes for shifting one or more of the stacked plates 50-55 relative to optical path OP. Three exemplary vibrating modes will now be described herein.

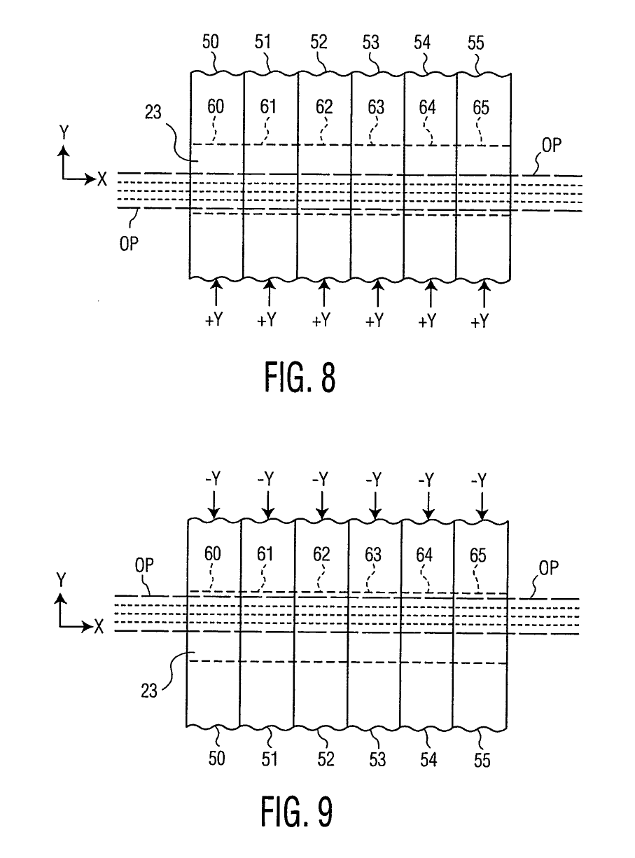

One vibrating mode involves a collective and equal upward shift of plates 50-55 in a +Y direction as exemplary illustrated in FIG. 8, and a collective and equal downward shift of plates 50-55 in a −Y direction as exemplary illustrated in FIG. 9. This aforementioned lateral shifting is accomplished in an oscillating manner to vibrate dichroic filter 23.

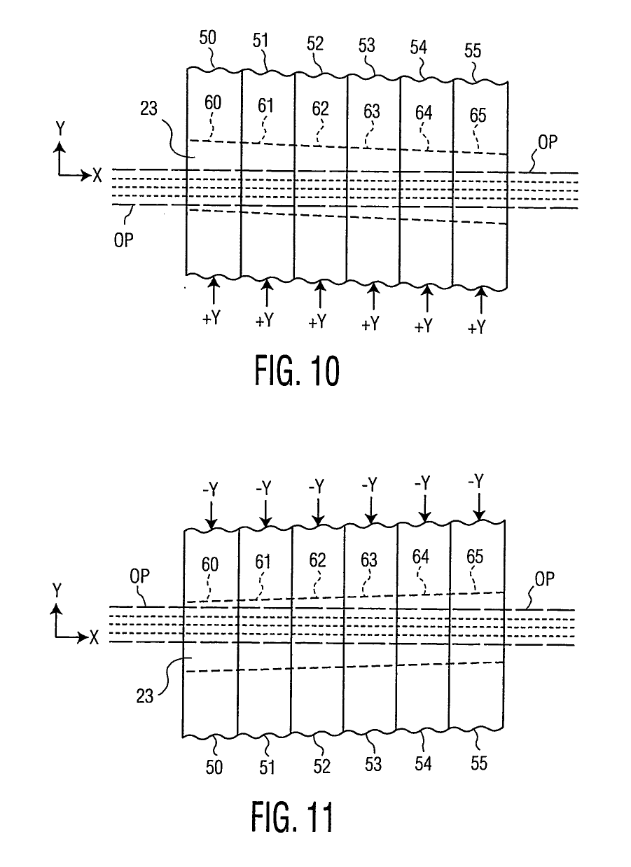

A second vibrating mode involves a collective and unequal upward shift of plates 50-55 in a +Y direction as illustrated in FIG. 10, and a collective and unequal downward shift of plates 50-55 in a −Y direction as illustrated in FIG. 11 in an oscillating manner to vibrate dichroic filter 23. This aforementioned wave shifting is accomplished in an oscillating manner to vibrate dichroic filter 23.

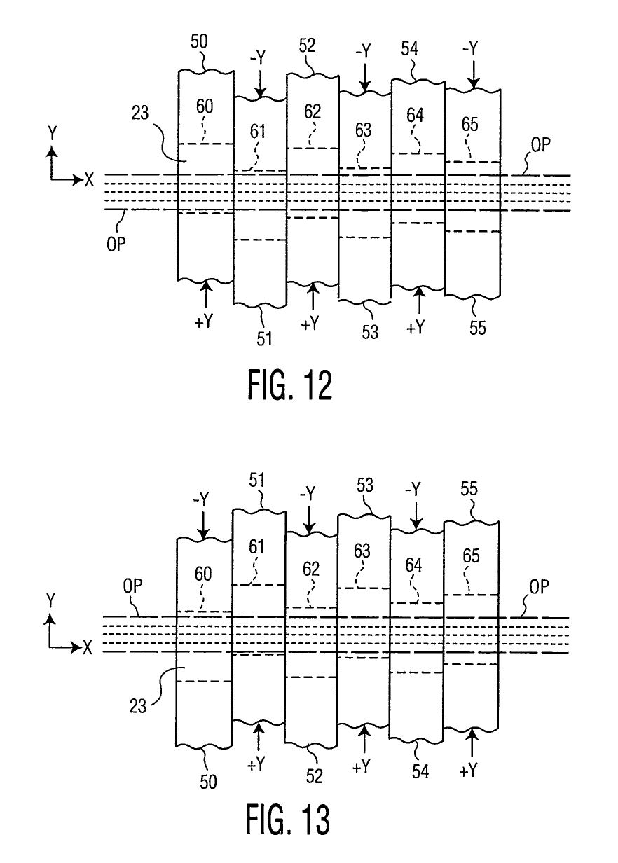

A third vibrating mode involves a simultaneous unequal upward shift of plates 50, 52 and 54 in the +Y direction and unequal downward shift of plates 51, 53 and 55 in the −Y direction as illustrated in FIG. 12, and a simultaneous unequal upward shift of plates 51, 53 and 55 in the +Y direction and unequal downward shift of plates 50, 52 and 54 in the −Y direction as illustrated in FIG. 13 in an oscillating manner to vibrate dichroic filter 23. This aforementioned meandering shifting is accomplished in an oscillating manner to vibrate dichroic filter 23.

Those having ordinary skill in the art will recognize that a desired shifting of one or more stacked plates 60-65 must take into account any shifting of underlying plates, and therefore the corresponding control signal must be computed in view any shifting of underlying plates. For example, a desired shifting of plate 50 must take into account any shifting of the underlying plates 51-55, and control signal CS I must be computed in view of any shifting of underlying plates 51-55.

In practice, the structural embodiments of plates 50-55, transducer units 80-85 and springs 90-95 are dependent upon a particular commercial implementation of transducer 50. In a basic embodiment, plates 50-55 are made from a metal having a suitable stiffness for operating plates 50-55 as described herein, transducer units 80-85 employ a metal rod within an electromagnetic coil for operating units 80-85 as described herein, and springs 90-95 are blade springs having a suitable tension for operating springs 90-95 as described herein.

From the description herein of 6th order electromechanical wave transducer 40 (FIGS. 2-10), those having ordinary skill in the art will appreciate how to make and use any Nth order electro-mechanical wave transducer in accordance with the present invention, where N≧1 and a dichroic filter can be embedded within any of the shifting plates (e.g., embedding dichroic filter 23 within aperture 61 of plate 51). Additionally, those having ordinary skill in the art will appreciate the unlimited types of display panels that can be employed with an Nth order electro-mechanical wave transducer in accordance with the present invention, such as, for example, a LCoS display panel and a deformable mirror display panel. Furthermore, those having ordinary skill in the art will appreciate the unlimited types of display systems that incorporate an Nth order electromechanical wave transducer in accordance with the present invention, such as, for example, a projection display system and a direct view display system. In the case of the direct view display system, those having ordinary skill in the art will appreciate the application of the present invention as part of a backlight unit used to illuminate the system, which has a larger display panel that is being directly observed by an observer without the need for magnification by a projection lens (e.g., projection lens 32 illustrated in FIG. 1).

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A display system (20), comprising:
a light source (21) operable to emit a light;
a display panel (31); and
an optical filter (23) operable to be vibrated,
wherein an emission of the light by said light source (21) propagates along an optical path (OP) extending from said light source (210 through said optical filter (23) to said display panel (31), and
wherein said optical filter (23) is vibrated during the emission of the light by said light source (21).

2. The display system (20) of claim 1, further comprising:
means for vibrating said optical filter (23) as a function of a Fourier waveform.

3. The display system (20) of claim 1, further comprising:
an electromechanical wave transducer (24, 40) operable to vibrate said optical filter (23).

4. The display system (20) of claim 3,
wherein said electromechanical wave transducer (40) includes a first plate (50) having a first aperture (60); and
wherein said optical filter (23) is embedded with said first aperture (60) of said first plate (50).

5. The display system (20) of claim 4,
wherein said electromechanical wave transducer (40) further includes a second plate (51) having a second aperture (61) sequentially arranged with said first aperture (60) in a direction of the propagation of the light through said optical filter (23).

6. The display system (20) of claim 4,
wherein said electromechanical wave transducer (40) further includes a transducer unit (80) operable to shift said first plate (50) in an oscillating manner relative to the optical path (OP) thereby vibrate said optical filter (23).

7. The display system (20) of claim 6,
wherein said transducer unit (80) is controlled by a control signal (CS1) having a signal waveform for facilitating a desired illumination of the emitted light on said display panel (31).

8. The display system (20) of claim 1,
wherein a vibrating waveform of said optical filter (23) relative to the optical path (OP) includes at least one of a saw tooth vibrating waveform, a step vibrating waveform, and a block vibrating waveform.

9. The display system (20) of claim 1,
wherein said optical filter (23) is a dichroic filter.

10. The display system (20) of claim 1,
wherein said display panel (31) is one of a deformable mirror display panel or a LCoS display panel.

11. The display system (20) of claim 1,
wherein the display system (20) is one of a projection display system or a direct view display system.

12. A method of operating an illumination system (20) including a light source (21), a display panel (31), and an optical filter (23), the method comprising:
emitting a light from the light source (21);
propagating the emitted light through the optical filter (23) to the display panel (31); and
vibrating the optical filter (23) as the emitted light propagates through the optical filter (23).

13. The method of claim 12,
wherein the optical filter (23) is embedded within an aperture (60) of a plate (50); and
wherein the vibration of the optical filter (23) includes a shifting of the plate (50) relative to the propagation of the emitted light through the optical filter (23).

14. A display system (20), comprising:
a optical filter (23); and
an electromechanical wave transducer (24, 40) operable to vibrate said optical filter (23) as light is propagated along an optical path (OP) traversing through said optical filter (23).

15. The display system (20) of claim 14,
wherein said electromechanical wave transducer (40) includes means for vibrating said optical filter (23) as a function of a Fourier waveform.

16. The display system (20) of claim 14,
wherein said electromechanical wave transducer (40) includes a first plate (50) having a first aperture (60); and
wherein said optical filter (23) is embedded with said first aperture (60) of said first plate (50).

17. The display system (20) of claim 16,
wherein said electromechanical wave transducer (40) further includes a second plate (51) having a second aperture (61) sequentially arranged with said first aperture (60) in a direction of the propagation of the light through said optical filter (23).

18. The display system (20) of claim 16,
wherein said electro-mechanical wave transducer (40) further includes a transducer unit (80) operable to shift said first plate (50) in an oscillating manner relative to the optical path (OP) thereby vibrate said optical filter (23).

19. The display system (20) of claim 18,
wherein said transducer unit (80) is controlled by a control signal (CS1) having a signal waveform for facilitating a desired illumination of the emitted light on said display panel (31).

20. The display system (20) of claim 14,
wherein a vibrating waveform of said optical filter (23) relative to the optical path (OP) includes at least one of a saw tooth vibrating waveform, a step vibrating waveform, and a block vibrating waveform.

21. The display system (20) of claim 14,
wherein said optical filter (23) is a dichroic filter.

22. The display system (20) of claim 14,
wherein the display system (20) is one of a projection display system or a direct view display system.
